(19) United States
(12) Patent Application Publication
(10) Pub. No.: US 2007/0237380 A1
(43) Pub. Date: Oct. 11, 2007

(54) Three-dimensional medical image display device equipped with pre-processing system implementing clinical protocol

(75) Inventors: Akio Iwase, Brisbane, CA (US); Keiji Ito, Burlingame, CA (US); Vikram Simha, Stow, MA (US); Robert James Taylor, Brisbane, CA (US); Motoaki Saito, Tokyo (JP); Kazuo Takahashi, Tokyo (JP); TieCheng Zhao, Concord, MA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Terarecon, Inc., San Mateo, CA (US)

(21) Appl. No.: 11/586,835

(22) Filed: Oct. 25, 2006

(30) Foreign Application Priority Data
Apr. 6, 2006 (JP) 2006-105747

(51) Int. Cl. G06K 9/00

(52) U.S. Cl. 382/131

(57) ABSTRACT

A three-dimensional medical image display system comprises a pre-processing device that includes data analysis device and a data processing device. The pre-processing device inputs a set of medical image data created by a scan performed by a medical imaging device. The data analysis device determines a set of analytic protocols for processing the image data by analyzing the image data. The data processing device processes the image data according to a protocol and a corresponding set of parameters identified by the data analysis device.

### FIELD OF THE INVENTION

This invention relates to a three-dimensional medical image display device which implements three-dimensional image processing of medical images based on parameters determined in advance by a preprocessing device on the basis of an analytic protocol.

### BACKGROUND

The remarkable technological progress in the area of recent X-ray and computed tomography (CT) devices made it possible to decrease the noise of X-ray detection devices and to increase spatial density of X-ray detection when compared to the initial X-ray CT devices thanks to X-ray CT devices which use multiple arrays of detectors with the helical scan method, enabling the acquisition of detailed projection data containing horizontal slices of the examined person in body axial direction in a short time period. This made it possible to obtain in this manner meaningful images, characterized by a low noise even with a thin depth of the slice in the image structure. Moreover, the capacity of image reconstruction devices has been also increased. Because these achievements also made it possible to increase the spatial resolution in the body axial direction, the number of images used for reconstruction images has been increased with a thin depth of the image reconstruction slice.

Therefore, as CT devices using multiple arrays of detectors became recently widely used for X-ray CT scanning operations, the precision of scanning in the body axial direction has been improved, and because this improved precision was accompanied by a higher density design in the space of the image reconstruction plane, generation of image data with a fine slice interval became possible. This was accompanied by a great increase in the number of image data pages generated with one scan. The number of magnetic resonance (MR) image data pages was also greatly increased in a similar manner with MR image data which is generated with one scan when compared to the initial devices. In the past, images were burnt as image data generated with one scan and the film created in this manner was then projected for inspection. However, when a great number of image data pages were generated with one scan, it became difficult to inspect all of these images in a film. That is why three-dimensional images were created from the image data obtained with scanning even for routine diagnostic reading and the images were observed in this manner, so that voxel data is then created by superimposing horizontal planes of image data of the examined person with three-dimensional image display devices using X-ray CT image data, so that three-dimensional images are created by performing three-dimensional processing and reconstruction operations. When X-ray CT image data is used which is obtained with X-ray CT devices using the latest multi-array detectors and the helical scan method, precise three-dimensional images having a high spatial resolution can be obtained.

When three-dimensional images are created from X-ray CT data, volume data is created by superimposing image data of horizontal profiles of an examined person in the body axial direction. If the number of image elements in a horizontal profile is for example 512×512 image elements and image data having image element dimensions of 0.5 mm×0.5 mm is superimposed with an interval of for example 0.5 mm in the body axial direction of the image data corresponding to 512 pages, a three-dimensional (3D) construction is obtained having 512×512×512 individual voxels contained in the spatial region of 256 mm×256 mm×256 mm. Next, three-dimensional images are created by performing three-dimensional reconstruction processing operations using surface rendering or volume rendering in the body axial direction of the construction created with these voxels. In this case, a memory making it possible to hold 256 MB of data is required to handle 16 bit data corresponding to 512×512×512 items.

When image elements of a horizontal profile comprising 512×512 image elements with the image element dimensions of 1.0 mm×1.0 mm are superimposed with 1,024 pages using an interval of 1.0 mm, a three-dimensional structure can be created with 512×512×1,024 individual voxels having a spatial region corresponding to 512×512×1,024 mm. Next, a three-dimensional image is created by performing three-dimensional reconstruction processing operations using surface rendering or volume rendering of three-dimensional volume data created with these voxels. In this case, a memory enabling to hold 512 MB of data will be required in order to handle 16 bit data which has 512×512×1,024 items. In addition, reconstruction processing operations which have been conducted most recently were also performed using image element dimension corresponding to 1,024×1,024 image elements, applied with 2,000 or 4,000 pages using an interval of 0.4 mm in the body axial direction of image data having image element dimensions of 0.4 mm×0.4 mm. When three-dimensional images are created with this image data, an image memory of 8 GB is required to handle 16 bit data corresponding to 1,024×1,024×4,096 individual items.

Data related to the heart of an examined person is gathered with synchronized electrocardiogram operations. For example, the diagnostic reading of data can be divided into 10 phases of projection data when the heart beat is divided into 10 equivalent segments, each corresponding to 1/10 heart beat intervals. Therefore, the projection data in each phase uses image data corresponding to 10 phases of reconstructed image data created from this projection data. If the dimensions per each phase correspond, to 512×512 image elements, for example with the image elements of a horizontal profile, and the image data of 0.5 mm×0.5 mm is superimposed with 512 pages using an interval of 0.5 mm in the body axial direction of the image, a three-dimensional body is created having spatial regions corresponding to 256×256×256 mm, with 512×512×512 individual voxels. Next, a three dimensional image is created by performing three-dimensional reconstruction processing operations using volume rendering or the like, which is applied to the three-dimensional volume data constructed of these voxels. A memory enabling to hold 256 MB of data is required in order to handle 16 bit data with 512×512×512 individual items per 1 phase. Therefore, to handle 10 phases of data, 256 MB/phase×10 phases=2.5 GB will be required.

When a great amount of pages is created containing image data generated with one examination, it is difficult to observe all of the images when a two dimensional image containing the image data that has been created is displayed in the same manner as in the past. That is why a three dimensional image is created from the image data obtained during one examination and this image is then observed. However, because a three-dimensional image of the human body has many organs creating overlapping images, to make it possible for a medical doctor and other medical treatment professionals to observe organs which they are interested in, it is necessary to display selective organs of interest or spatial regions of interest, and to ensure that other organs or other spatial regions will not be displayed. For example, to conduct a pulmonary examination, it is necessary to ensure operations so that only the pulmonary region will be extracted and the influence of the peripheral bones will be excluded, etc. These operations require a great number of steps, such as when only a specific range of CT values must be extracted and a specific spatial region must be specified for extraction of this region, etc. This means that an operator who possesses medical knowledge pertaining to the structure of human body as well as experience will be required for such operations.

The following is an explanation of common three-dimensional image display devices used in the past. FIG. 4 is a block diagram showing a conventional three-dimensional image display device. In FIG. 4:

Number 101 indicates an example of an image diagnostic device such as an X-ray CT device, MR device, or the like;

Number 102 indicates an example of an image data archiving system such as a PACS server or the like;

Number 103 designates an example of an information system such as a radiology information system (RIS) or the like.

Number 104 designates an example of an information system such as a hospital information system HIS or the like;

Number 105 designates an example of an internal hospital network;

Number 111 indicates image data obtained with an X-ray scan of an examined person performed with an X-ray CT device 101 when the image data was processed with reconstruction processing;

Number 112 indicates image data transmitted from an X-ray CT device 101 or a PACS 104 to the three-dimensional image display device 111; Number 113 indicates information related to scans supplied from the RIS 103 to an operation device 115 of a three-dimensional image display device;

Number 121 indicates a three-dimensional image display device;

Number 122 is an image data storage device whose construction comprises a magnetic disk, etc.;

Number 123 is an image processing device;

Number 124 is an image display device;

Number 125 is an operation device;

Number 126 designates an example of an operator operating a three-dimensional image display device;

Number 131 indicates operations performed by an operator;

Number 132 indicates control information transmitted from the operating device 125 to the image data archiving device 122;

Number 133 indicates image data sent from the data archiving device 122 to an image processing device 123;

Number 134 indicates operations performed by an operator 126 such as indication of image processing parameters or the like;

Number 135 indicates control information such as image processing parameters transmitted from the operation device 125 to the image processing device 123;

Number 136 indicates image data after image processing operations have been carried out by the image processing device 123;

Number 137 indicates the observation process of the operator 126 who is observing an image displayed on the image display device 124;

Number 138 indicates corrections performed during the thinking process when image processing parameters are applied by the operator 126 to the initial processing of images which are observed as images displayed on the image display device 124;

The image data storage device 122 reads from an electromagnetic disk image data displayed by an operation part 125 and this image data 133 is sent to an image processing device 123.

The image processing device 123 performs image processing operations using image processing parameters 135 indicated by the processing device 125 for the image data 133, and the image data 136, processed with these image processing operations, is then displayed on the image display device 124.

An operator 126 examines the image displayed on the image display device 124, corrects instructions 134 for the image processing parameters that were used initially for image processing operations, and new instructions 134 are issued.

New parameters 135 are sent from the operation part 125 to the image processing device 123, image processing operations are carried out on the basis of the new image processing parameters 135 by the image processing device 123 and the image display device 124 displays image-processed image data 136.

The operator 126 observes an image displayed on the image display device 124, corrects the instructions 134 which were used for processing of images that were performed initially and new instructions 134 are issued. New image processing parameters 135 are sent from the operation device 125 to the image processing device 123, the image processing device 123 performs image processing operations on the basis of the new image processing parameters 135, and the image display device 124 displays image data 136 processed with these image processing operations.

The result of the image processing parameter which has been indicated in this manner by the operator is determined and corrected with a visual evaluation of the displayed image.

When a large number of image processing operations is thus performed sequentially, while processing of bones and the like is excluded, the operator must carry out sequentially a large number of image processing operations.

FIG. 5 shows a flow chart explaining the operation of a conventional three-dimensional display device. At 501 a patient is scanned with an X-ray CT device 101. At 502 data storage device 122 stores the image data which has been scanned with the X-ray CT device 101. At 503 an operator selects scanning with an operation device 125 and sends image data from the image data storage device 122 to an image processing device 123. At 504 the operator determines an analytic protocol that is suitable for this type of image data. At 505 the operator specifies sequentially the type of image processing that is required to implement the determined analytic protocol, as well as the parameters for the image processing device 123. At 506 the image processing device 123 performs specified image processing operations and the result is displayed by an image display device 124. At 507 the operator 126 confirms the processing result. If the result is not satisfactory, the operator corrects the parameters and issues instruction to run processing operations again. Hence, if the processing results are OK at 508, the process proceeds to 509; otherwise, the process loops back to 506. If all image processing operations finished at 509, the process ends; otherwise, the process loops back to 505.

Many diagnostic protocols have been proposed which can be used in order to perform image diagnosis using three-dimensional images according to the purpose of the image analysis, and also analytic application software packages have been created with a protocol suitable for each application. The structure of respective analytic protocols or analytic application software packages comprises image analysis sequences, wherein image processing or image analysis operations are performed sequentially according to these sequences, so that the target analysis images or various types of analytic parameters and specific values are obtained in the end.

The operations used to perform a series of image processing or image analysis operations are complicated and they also include many steps. Because of that, the operator spends a long period of time in this manner. The result is that only the analytical protocol pertaining directly to the target of the examination is carried out, while it is not possible to request the gathering of image data obtained in scans when another analytic protocol has not been realized.

During processing operations such as bone extraction or the like, sequential processing of many images is performed to in order to realize successive processing of a great number of images. If a template has been prepared ahead of time for the operations which are carried out by the operators, a so called Wizard feature is sometime created based on this template to facilitate the performance of sequential operations so that questions can be answered in an interactive manner, which is a function that is built into a complicated software application to facilitate the operations.

When the Wizard feature is invoked, this greatly alleviates the burden placed upon the operator during the operations, because the input can be done in a simple manner with an interactive window. However, the scope of the operations which can be performed with the Wizard feature is limited and in many cases, only basic operations which are frequently used can be automated on a practical level.

### SUMMARY OF THE INVENTION

The present invention includes a method of pre-processing medical image data prior to display. According to certain embodiments of the invention, the method comprises inputting medical image data created by an imaging scan performed by a medical imaging device, automatically analyzing the image data to identify a set of analytic protocols for processing the image data, selecting an analytic protocol of the set of analytic protocols, identifying a set of parameters corresponding to the selected analytic protocol, and processing the image data according to the selected analytic protocol and the set of parameters.

Other aspects of the invention will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 is block diagram explaining an embodiment of the invention;

FIG. 2 is a flowchart explaining an embodiment of the invention;

FIG. 3 is a flowchart explaining an embodiment of the invention;

FIG. 4 is block diagram explaining a conventional three-dimensional image display device; and

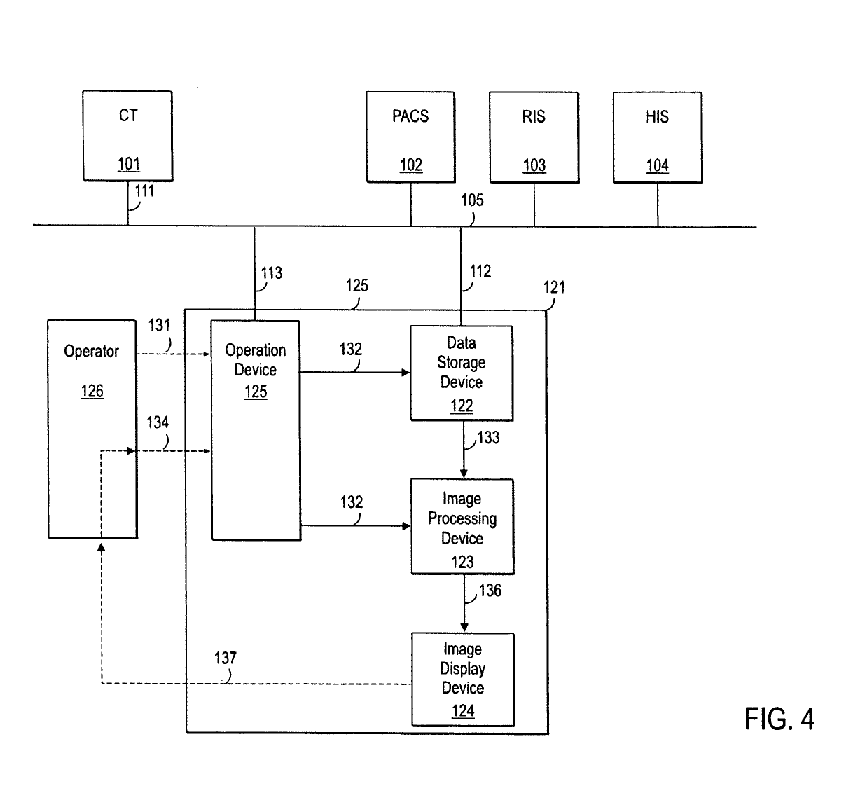

FIG. 5 is a flowchart explaining a conventional three-dimensional image display device.

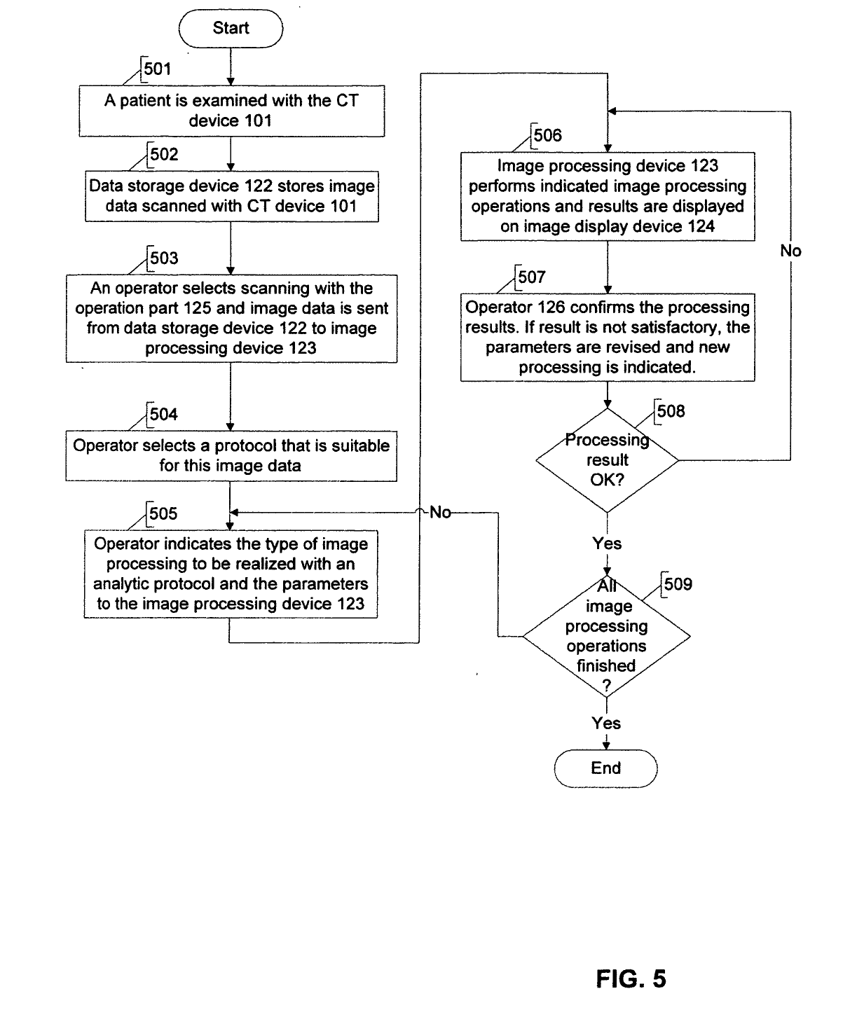

### DETAILED DESCRIPTION

A purpose of the solution introduced here is to decrease the operating time and the operating steps required to perform image analysis operations using a three-dimensional medical image display device. Accordingly, a preprocessing device is equipped with a function wherein aggregates of image data are scanned with an image diagnosis device, requested information is obtained from an image system, image-attached information, information contained in a human body atlas and similar information is analyzed and the purpose of the scan and scan regions are determined, a protocol is determined for image analysis based on this information, and image analysis processing operations are performed according to the image analysis protocol and applied to aggregates of image data, having a function outputting analytic parameters and characteristic values. An image display device uses a configuration wherein various types of analytic parameters and characteristic values are determined with a preprocessing device for said image data aggregates, and a desired analysis image is displayed by an operator who is operating image analysis application software according to a corresponding diagnostic protocol. This makes it possible to decrease the operating time and the operating steps required to perform image analysis operations using a three-dimensional image display device.

Along with the technical progress achieved with the latest medical image diagnosis devices, the amount of data which is used as medical image data obtained with one scan has been rapidly increasing. For example, during X-ray CT scanning, with the popularization of the latest X-ray CT device using multiple arrays of detectors, the precision of scanning in the body axial direction has been increased so that data can be created using fine spacing between the slices. This has been also accompanied by a great increase of the number of pages of image data which can be created with one scan. In the past, image data that was created with one scan was either burned onto a film, or imaging operations were performed by displaying the image data on an image display device. However, when a great number of pages are created with one scan, this renders observation of all of the images on a film or on an image display device difficult. Because of that, three-dimensional images are created from the image data obtained during the scan and these images are then observed.

However, when three-dimensional images relating to a great number of body organs in human body are superimposed, to make it possible for a medical doctor or another medical treatment professional to observe the body organ of interest, a design must be created wherein this body organ of interest or the spatial region of interest will be selectively displayed, while other organs or other spatial regions will not be displayed. For example, when pulmonary observation is to be conducted, it is necessary to perform operations ensuring that only the pulmonary region is extracted, while the influence of the peripheral auxiliary bones is excluded, etc. However, because such operations require image processing to be performed only with a specified range of CT values, or extraction of specified spatial regions, etc., a considerably large number of steps are required during the image processing operations. Moreover, the operators must have medical knowledge, as well as knowledge pertaining to the structure of human body and experience.

These image processing operations are performed when an operator is sequentially executing instructions with an operation device, so that image processing is performed based on the instructions of the image processing device, and the result of the image processing operations, displayed on an image display device, is visually confirmed by the operator during the successive performance of the operations. Because these types of image processing operations require time for processing, the operator will spend a long time until the final result is obtained. Along with the progress achieved in the high-speed design of X-ray CT device and MR devices, the time required for scanning has been also reduced. However, although a great number of scans can be realized per day, since a long time is spent on the processing of three-dimensional images per one scan, the efficiency of a medical doctors or a medical treatment specialist is poor as the diagnosis using processing of three-dimensional images has not been developed or widely used.

In the accompanying figures, reference numerals have the following meanings:

101: an X-ray CT device, MR device or a similar image analysis device

102: an image data archiving system such as a PACS server or the like

103: an information system such as a radiology information system (RIS) or the like

104: an information system such as a hospital information system (HIS) or the like

105: internal hospital network

111: reconstructed and processed image data scanned by an operator with and X-ray CT device using X-ray scanning

112: image data sent from an X-ray CT device or PACS to a three-dimensional image data device

113: scan-related information supplied from an RIS to an operation device of a three-dimensional image display device

121: three-dimensional image display device

122: image data archiving system constructed with a magnetic disk or the like

123: image data processing device

124: image data display device

125: operation part

126: an operator operating a three-dimensional image display device

131: operations performed by an operator

132: control information transmitted from an operation part to an image data archiving device

133: image data sent from a data archiving device to an image processing device

134: operations performed by an operator such as displaying of image processing parameters or the like

135: control information such as image processing parameters transmitted from an operation device to an image processing device or the like

136: image data processed by an image processing device

137: a process wherein an operator observes images displayed on an image display device

138: a step in which an operator observes an image displayed on an image display device and corrects instructions for image processing parameters

221: preprocessing device

222: image data archiving device constructed with a magnetic disk or the like

223: data processing device

224: parameter archiving device

225: data analysis device

226: knowledge database

231: image data sent from a data archiving device to a data processing device

232: image image-attached information sent from a data storage device to a data analysis device

233: signal sent from a data analysis device to a data processing device

234: signal sent from a data processing device to a data analysis device

235: signal sent from a data processing device to a parameter storage device

241: a device for processing of three-dimensional images

243: image processing device.

244: image display device

245: operation device

246: an example of an operator who operates a three-dimensional image display device

251: signal sent from a parameter storage device to an operation device

252: operations performed by an operator

253: control information transmitted from an operation part to an image processing device

254: image data sent from a data storage device to an image processing device

255: image data processed with image processing operations by an image processing device

256: the process wherein an operator observes an image displayed on an image display device

257: the process wherein an operator observes an image displayed on an image display device and corrects image processing parameters

This invention provides a way to shorten the time which is spent by a medical doctor, medical treatment professional or the like who uses a device for processing of three-dimensional images for processing of three-dimensional images in order to perform a high-level diagnosis.

When the scanning of a patient with an X-ray CT device is finished, the image data obtained during the scanning is transmitted to a preprocessing device. The preprocessing device distinguishes, in the target scans of specified data of a hospital information system (HIS) which is used with the indicated X-ray CT scans of a radiation region, information system items including the scan region, the age and the gender of the examined person, and the image data is analyzed based on these obtained scans. During this analysis, the preprocessing device uses previously seen information which is available, such as a human body atlas represented by a three-dimensional graph indicating the construction of a human body, CT values or the like indicating each region of the human body. Moreover, the preprocessing device also uses a knowledge database containing analysis data accumulated during the course of the operations. The scanned region and the target of the scanning are comprehended based on this analysis, while multiple analytic protocols are determined based on this information. Image processing operations are executed with image processing parameters which are based on the analytic protocol obtained during the scanning, various types of parameters are extracted and the obtained parameters are stored.

When a medical doctor or a medical treatment professional or the like uses a three-dimensional image processing device, image processing is executed with each type of parameters that were obtained with the preprocessing device and that are suitable for the image data obtained during the scanning, so that the processing results are obtained with the requested parameters.

Because image processing is realized by the preprocessing device with the suitable type of parameter, a medical doctor or a medical treatment professional can abridge to a large extent various operations, which makes it possible to greatly shorten the time period spent on the reading and interpretation of images.

When the results of the latest techniques for processing of three-dimensional images are applied to image diagnosis, this makes it possible to solve the problem created when the time required for the three-dimensional analysis is greatly extended.

In addition, because image processing operations are executed with various types of suitable parameters obtained from the preprocessing device, and because the time spent on the reading and interpretation of images by a medical doctor or a medical treatment specialist or the like can be greatly shortened, this makes it possible to realize optimal image data which is scanned with many types of analytic protocols. Because of that, reading and interpretation of images data has been simplified based on a plurality of protocols, which was difficult to realize due to restrictions on the time that was available for reading and interpretation performed by medical doctors or other workers in the past.

This invention provides a way to shorten the time period during which a three-dimensional image processing device is used by a medical doctor or a medical treatment professional or the like in order to further extend a high-level analysis using three-dimensional image processing operations.

When the scanning of a patient by an X-ray CT device is finished, the image data obtained during the scanning is transmitted to a preprocessing device. Because the preprocessing device distinguishes items such as the purpose of the scan, the scanned region, the age and the gender of the patient and the like based on the instruction data of a hospital information system or of a radiation region information system that is indicated for an X-ray CT scan, the image data is analyzed based on this information. Information such as a human atlas in the form of a human body diagram indicating the structure of human body available to the preprocessing device, as well as previously seen information, such as CT values applicable to each region of human body, are used for this analysis together with a knowledge data base containing analysis data accumulated during the operations of the preprocessing device in the past. Because items such as the purpose of the scan and the scanned regions are comprehended during this analysis, image processing operations are applied to image data obtained on this basis during the scanning, so that various types of parameters are extracted automatically and each parameter type is stored.

A medical doctor or a medical treatment professional uses a three-dimensional image processing device and executes image processing operations with each type of suitable parameters obtained with the preprocessing device applied to image data obtained during the scanning. Because image processing operations are performed with each type of suitable parameters obtained with the preprocessing device, this makes it possible to greatly abridge the operations performed by a medical doctor or a medical treatment professional, so that the time period spent of image processing can be shortened to a large extent.

When the results of the latest techniques available for processing of three-dimensional images are suitably applied to image diagnosis, the problem wherein a long period of time is in the end required for an analysis of three-dimensional images can thus be dealt with.

This invention makes it possible for medical doctors, medical treatment professionals and the like to use image data obtained during scanning so that three-dimensional images are prepared, the regions of interest are extracted using these three-dimensional images, and the measurement values relating to these regions of interest are determined. Therefore, when an image diagnosis is performed, the operations performed by a medical doctor or a medical treatment specialist or the like can be greatly abridged by performing image processing using each type of suitable parameters obtained with a preprocessing device, which makes it possible to greatly shorten the time period required for processing of images.

According to this invention, a preprocessing device is used to perform an image analysis and image processing operations by following a menu that is assumed in advance. Because various types of analytic parameters are extracted and stored, a medical doctor or a medical treatment professional uses the image data that was obtained during the scanning so that when reading and interpretation or image diagnosis operations are performed, each type of analytic parameters that has been stored is reviewed, enabling to confirm again the analytic parameters which have been determined as being necessary by a medical doctor or by a medical treatment specialist. Because of that, a medical doctor or a medical treatment specialist or the like can make a comparison based on analytic parameters determined in this manner during the manual operations of a medical doctor or a medical treatment specialist. Since the operations that need to be performed by a medical doctor or a medical treatment specialist can be greatly abridged, the time required for the confirmation of a great number of analytic protocols can be shortened to a large extent.

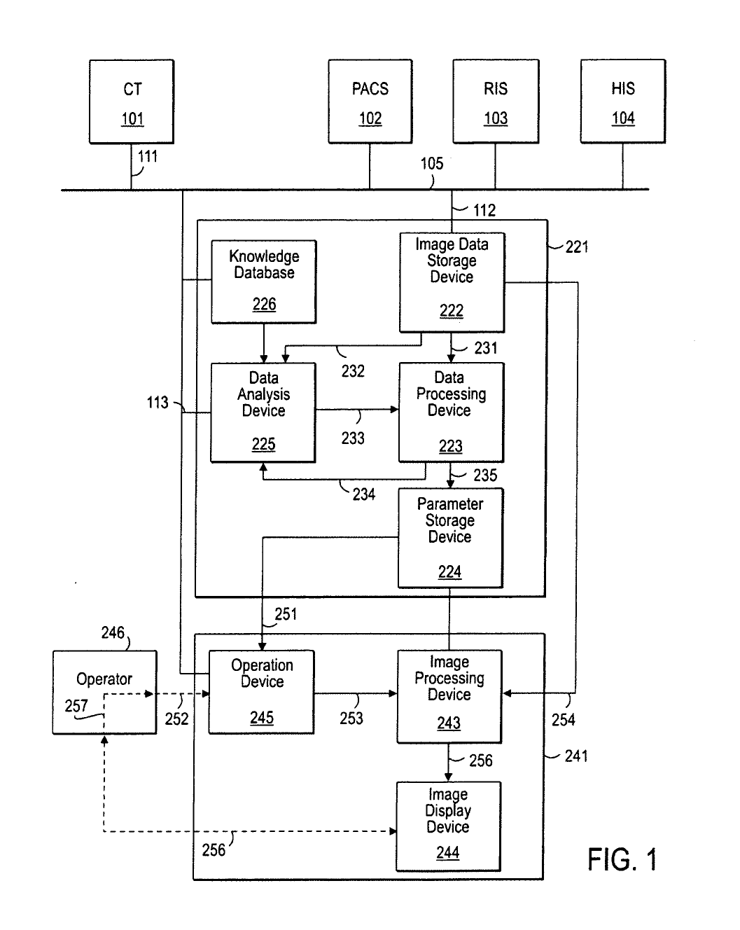

The following is an explanation of an embodiment of this invention. FIG. 1 is a block diagram showing a three-dimensional image display device equipped with a preprocessing device based on an analytic protocol according to this invention. In FIG. 1:

101 indicates an example of an image diagnosis device such as an X-ray CT device, an MR device or the like;

102 indicates an example of an image data archiving system such as a PACS server, etc.

103 indicates an example of an information system such as a radiology information system (RIS) or the like;

104 indicates an example of an information system such as a hospital information system (HIS) or the like;

105 indicates an example of an internal hospital network;

111 indicates image data which has been scanned with the X-ray CT device 101 and processed during reconstruction processing;

112 indicates image data sent from the X-ray CT device 101 or from the PACS 102 to a preprocessing device 221;

113 indicates scan-related information supplied from a RIS 103.

221 is a preprocessing device;

222 is an image data archiving device whose construction comprises a magnetic disk, etc.;

223 is a data processing device;

224 is a parameter storage device;

225 indicates a data analysis device;

226 is a knowledge database;

231: image data sent from a data storage device to a data processing device;

232: image-attached information sent from a data storage device to a data analysis device;

233: signal sent from a data analysis device to a data processing device;

234: signal sent from a data processing device to a data analysis device;

235: signal sent from a data processing device to a parameter storage device;

241 indicates a device for processing of three-dimensional images;

243 is an image processing device;

244 is an image display device;

245 indicates an operation device;

246 indicates an example of an operator who operates a three-dimensional image display device;

251: signal sent from a parameter storage device to an operation device;

252: operations performed by an operator;

253: control information transmitted from an operation part to an image processing device;

254: image data sent from a data storage device to an image processing device;

255: image data processed with image processing operations by an image processing device;

256: the process wherein an operator observes an image displayed on an image display device;

257: the process wherein an operator observes an image displayed on an image display device and corrects image processing parameters.

The data analysis device 225 refers to a knowledge database 226 based on DICOM information, which includes image-attached information sent from the data storage information 222 and patient order information 113 sent from the RIS 103, and performs data analysis.

The output signal 233 of the data analysis device 225 is sent to the image processing device 223 and image processing operations which are applicable to the image data 231 are performed. The result 234 of this image processing is returned to the data analysis device 225 and a comparison is performed.

When these operations are conducted repeatedly in this manner, the parameters for various types of image processing operations stored in image data 231 are extracted together with analytic parameters. The extracted parameters are stored in the parameter storage device 224.

The operator 246 reads, interprets and selects information contained in executed scans from the information obtained from the RIS information 113 displayed by the operation device 245, and from the parameter storage device 224, and executes operations 252 with a specified analytic protocol.

When the signal obtained from the operation device 253 is sent to the image processing device 243, the image processing device 243 reads the scan data from the data storage device 222. While the analytic parameters obtained from the parameter storage device 224 are read and input at the same time, image processing operations are performed and the image data processed with the image processing operations are sent to the display device 244. The display device 244 displays image data.

The operator 246 observes the data and the image data displayed on the image display device 244 and corrects the parameters if the he feels that a modification of the parameters is required.

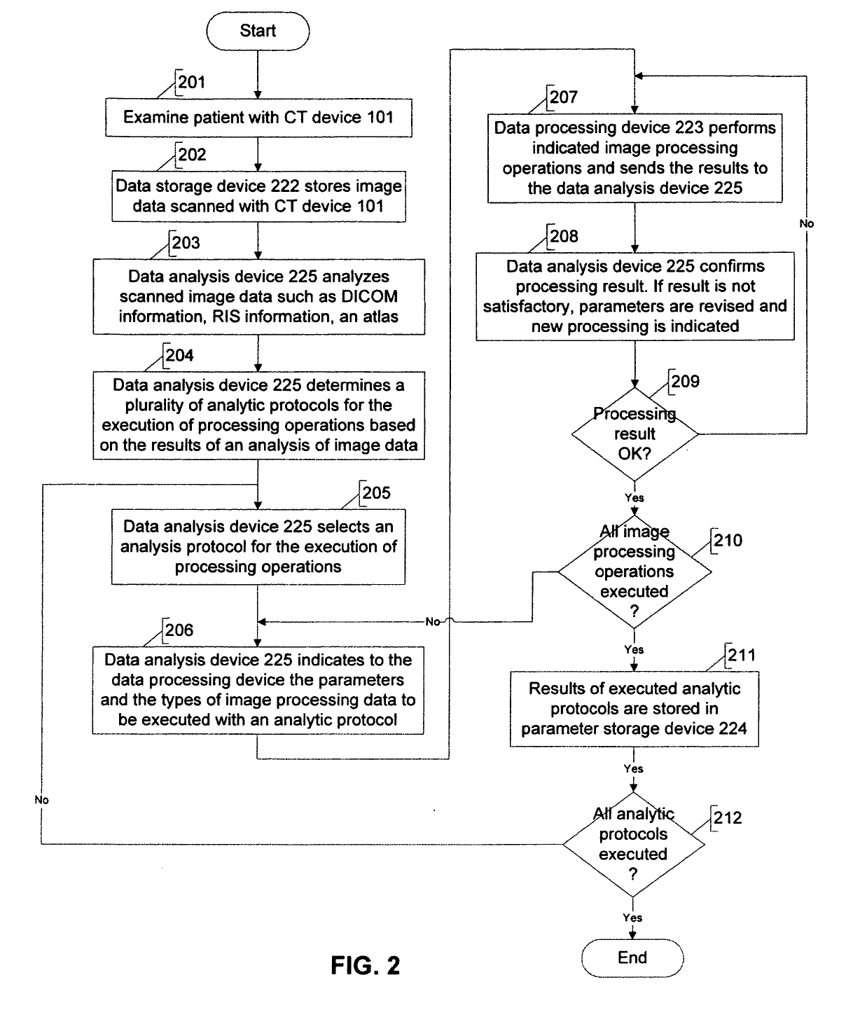

FIG. 2 is a flowchart explaining the present embodiment relating to the part represented by the preprocessing unit. At 201, a patient is scanned with an X-ray CT device 101. At 202, the data storage device 222 stores image data scanned with the CT device 101. At 203, the image data that has been scanned with the data analysis device 225 is analyzed based on DICOM information, RIS information, an atlas of images and the like. At 204, the data analysis device 225 determines a plurality of analytic protocols to perform processing based on the results of an analysis of the image data. At 205, the data analysis device 225 selects an analytic protocol to implement processing. At 206, the data analysis device 225 indicates to the data processing device the type of image processing operations which are required to implement the analytic protocol, as well as the parameters. At 207 the data processing device 223 performs specified image processing operations and sends the result to the data analysis device 225. At 208 the data analysis device confirms the processing result. If the result is not satisfactory, the parameters are corrected and an instruction is sent to run the processing operations again. At 209 it is determined whether the processing result is OK. If the answer is NO, the process loops back to 207 At 210 it is determined whether all image processing operations finished. If the answer is NO, the process loops back to 206. At 211 the result of implemented analytic protocols is stored in the parameter storage device 224. Finally, if all analytic protocols were implemented (212), the process ends, otherwise, the process loops back to 205 for the next analytic protocol.

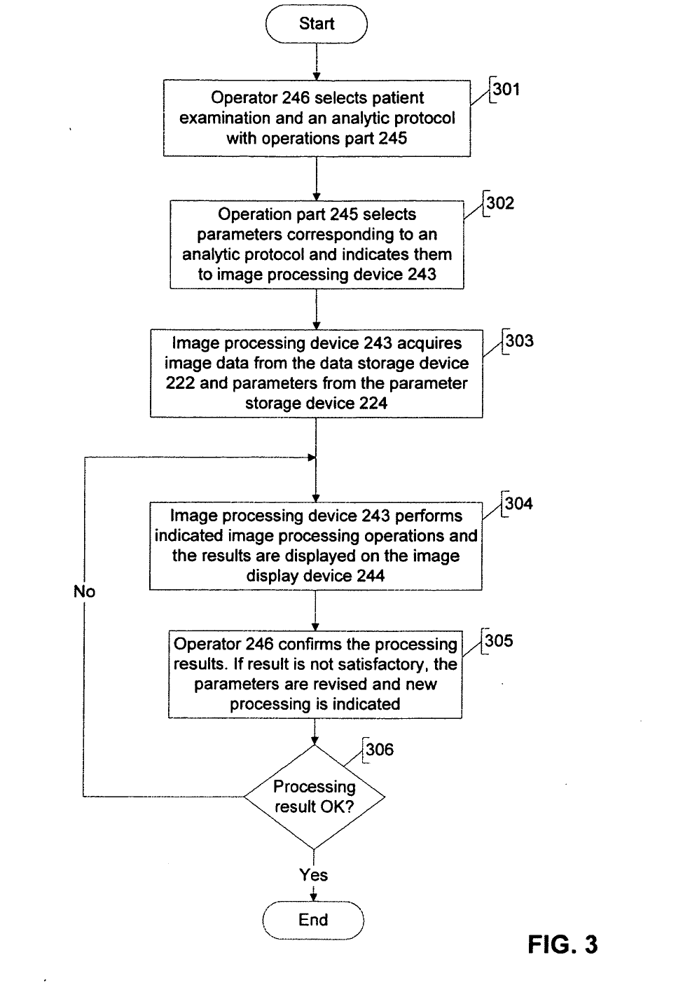

FIG. 3 is a flowchart explaining the present embodiment relating to the part represented by the three-dimensional image processing unit. At 301 an operator 246 selects patient-scan and an analytic protocol with an operation device 245. At 302 the operation device 245 selects parameters corresponding to an analytic protocol and sends an instruction to the image processing device 243. At 303 the image processing device 243 acquires image data from a data storage device 222 and parameters from a parameter storage device 224. At 304 the image processing device 243 performs specified image processing operations and the result is displayed by the image display device 244. At 305 operator 246 confirms the processing result. If the result is not satisfactory, the parameters are corrected and processing operations are indicated. If the processing result is OK at 306, the process ends; otherwise, the process loops back to 304.

As the preprocessing device comprehends the purpose of the scan, the scanned region, the age and gender of the patient using data specified by a radiation region information system or a hospital information system indicated with an X-ray CT scan, scanning is performed and the obtained image data is analyzed based on this data. The information includes:

(1) patient information contained in the ordered X-ray CT scans supplied from a hospital information system HIS.

(2) information such as the scan regions in which X-ray CT-scans were realized supplied from an radiation region information system.

(3) information contained in DICOM header information of DICOM image data.

Atlas mapping the human body in the form of three-dimensional images available to the preprocessing device, as well CT values and similar information pertaining to each region of human body, are analyzed using a knowledge database in which analysis data pertaining to past analyses are analyzed with the preprocessing device and the scan regions are comprehended by the preprocessing device. Examples of scan regions are:

(1) Head region—artery.

(2) Neck region—neck artery.

(3) Pectoral region—heat, left heart chamber, lungs, breasts, aorta thoracica.

(4) Abdominal region—aorta, torso, large intestine, artery.

(5) Pelvis—lumbar veterbrae.

(6) Four limbs—arms, legs.

(7) General blood vessels, tissues.

The data processing device of the preprocessing device can be equipped with many analytic engines. Examples of such functions are as follows:

### (1) CT Patient Table Deletion

Target modality: CT

Applicable to: Deletion of CT patient data from image data

Output: Mask distinguishing CT patient tables.

### (2) Functions Belonging to the Category Bones/Blood Vessels

Target modality: CT.

Function: Distinguishes between blood vessels and bones present in the data. Central lines are found in blood vessels.

Output: A mask distinguishing between bones and blood vessels, a list of central lines in blood vessels, etc.

### (3) Lungs—Lung nodules

Target modality: CT.

Function: 1) Distinguishes regions of the lesser tubercle in data related to lungs. 2) Determines coincidence with nodes in temporary data.

Output: Nodal regions:

Engine: An engine supplied by a CAD vendor.

### (4) Large Intestine—Large intestine, Paths of Incidence, Polyps

Target modality: CT.

Function: Distinguishes the position of a polyp in the large intestine data.

Output: Polyp position.

Engine: An engine supplied by a CAD vender.

### (5) Position Adjustment

### (5.1) CT/CTA Subtraction

Target Modality: CT.

Function: 1) Patient's CT and CTA spatial registration. 2) Subtraction of CT data from CTA.

Output: 1) Registration matrix. 2) DICOM data below the subtraction.

### (5.2) CT/PET

Target modality: CT and PET.

Function: CT and PET spatial registration for the same patient.

Output: Registration matrix.

### (5.3) MR

Target modality: Four-dimensional MR.

Function: Performs spatial registration of the MR time series in standard MR.

Output: Registration matrix.

### (6) Cerebral Flow

Target modality: CT.

Function: Performs a time concentration analysis of the brain data. Distinguishes automatically between the input and output function. The result is used to create a secondary acquisition image.

Output: Secondary acquisition images for various maps.

### (7) Heart Analysis.

### (7.1) Three-Dimensional/Four-Dimensional Chest Wall deletion

Target modality: Three-dimensional and four-dimensional CT.

Function: Deletion of the chest wall, or a four-dimensional mask.

Output: A mask distinguishing the chest wall.

(7.2a) Coronary Artery

Target modality: Three-dimensional and four-dimensional CT.

Function: Distinguishes and separates coronary artery from heart structures.

Output: A mask distinguishing arteries and center lines in each artery.

(7.2b) Coronary Artery

Target modality: Three-dimensional and four-dimensional CT.

Function: Detects and quantifies stenotic areas in the coronary arteries.

Output: A list of locations of potential stenoses and the percent narrowing detected.

### (7.3) Wall Motion

Target modality: Four-dimensional CT.

Function: Heart analysis.

Output: Segmented LV, time-volume curve, polar map.

### (7.4) Calcium Scoring

Target Modality: Three-dimensional CT.

Function: Performs calcium scoring.

Output: A mask distinguishing calcium.

Because it is determined in the knowledge base whether items such as symptoms, examinations, the content of the report and the like have been integrated into the database system, when the doctor who is in charge of the treatment places an order for imaging of a particular symptom, it is determined whether this order is appropriate based on an existing protocol used in the hospital. In cases when a specific examination is omitted, this can be pointed out. For example, in the case of chest pains, if there is a certain protocol for ordering of an examination including both an X-ray CT and an MR scan at a medical treatment facility, it can be specified that a certain medical doctor or a medical treatment specialist has ordered only an X-ray CT scan of this symptom and that a scan with MR has been omitted.

Since various types of image processing operations such as an unsharp mask, etc., are stored with processed images executed in advance for the CR image data acquired with a CR device, when processed images are displayed during the reading and interpretation of CR images, the existence of the system makes it possible to decrease image processing operations during reading and interpretation. With the three-dimensional display device of this invention, since an operator uses the preprocessing device to realize each step of the analytical sequence, as well as respective analytical parameters and specific values that have been stored, a sequential reproduction is enabled and the various types of analytical parameters and specific values can be modified as required. Because of that, a characteristic of the system is that many analytical sequences containing a number of steps can be executed without having to impose stress on the operator.

Thus, an embodiment of the invention comprises a three-dimensional image display device equipped with:

a function enabling to receive and store image data aggregates containing scans realized with an image diagnosis device and scan-related information;

a knowledge database function used in order to understand image data contained in a human body atlas and the like;

a function defining an analysis protocol determining the procedure for image analysis used for image analysis and to read and interpret images and the like;

a function analyzing information obtained from image data aggregates containing scan-related information and scans performed with an image analysis device, from a hospital information system (HIS), from a radiology information system (RIS), information obtained from a knowledge database containing a human body atlas, and information pertaining to scans performed with an image diagnosis device that have been realized so far, and similar information about the purpose of the scan, the scan region, and the like;

an analytic engine function, enabling to execute an image diagnosis sequence required to execute an analysis protocol, as well as the related image analysis,

a software application function for image analysis corresponding to an analysis protocol;

a preprocessing device, equipped with a function performing an analysis of the target of the scan and of the scan region, applied to an aggregate of image data of scans performed with an image diagnosis device, selecting a corresponding analysis protocol, executing sequentially image analysis sequences based on an analysis protocol with an analysis engine, determining automatically characteristic values and various types of analytic parameters required by image analysis application software, and performing the output and storage thereof;

with a function determining various types of analytic parameters and characteristics values applied to said image data aggregates in order to read and interpret or to perform an image analysis of image data aggregates with a preprocessing process device, used to operate image analysis application software according to an analysis protocol so that the analysis image requested by an operator is displayed, and the analytic data, characteristic values and the like can be reproduced;

an image display device, equipped with a function enabling an operator to correct various types of parameters and characteristic values required with the preprocessing device in respective steps of image analysis sequences constructed with image analysis application software;

in a three-dimensional image display device, wherein the burden imposed upon the operator during an image analysis by reading and interpretation of aggregates of image data, by image analysis and the like, is decreased by requesting ahead of time various types of image parameters and characteristic values, while at the same time, all suitable analytic protocols can be applied, enabling the operator to abridge the complexity of operations performed with conventional three-dimensional image display devices.

The preprocessing device further can be equipped with a function enabling to output various types of parameters and/or characteristic values which are required to create a reading and interpretation report.

Further, the preprocessing device can be equipped with a function outputting various types of parameters and characteristic values required to prepare a reading and interpretation report, and the operator performs a review and reconfirmation thereof, enabling to prepare a reading and interpretation report.

The preprocessing device and the image display device can be deployed in the same hardware or in different hardware.

In addition, the preprocessing device and the image display device can be arranged for distribution over a network.

Embodiments of the invention may also comprise an image analysis device, including an X-ray CT device, MR device, PET, an ultrasonic device or the like; wherein in addition to three-dimensional images, two-dimensional images can be also analyzed in the same manner.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable medium and may be executed by one or more general-purpose or special-purpose programmable microprocessors. A “machine-readable medium”, as the term is used herein, includes any mechanism that provides (i.e., stores and/or transmits) information in a form accessible by a machine (e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A machine-implemented method of pre-processing medical image data prior to display, the method comprising:
inputting medical image data created by an imaging scan performed by a medical imaging device;
analyzing the image data to identify a set of analytic protocols for processing the image data;
selecting an analytic protocol of the set of analytic protocols;
identifying a set of parameters corresponding to the selected analytic protocol; and
processing the image data according to the selected analytic protocol and the set of parameters.

2. A method as recited in claim 1, further comprising processing the image data according to each other protocol of said set of analytic protocols.

3. A method as recited in claim 1, further comprising:
determining if a result of said processing is satisfactory; and
if the result of said processing is not satisfactory, then modifying the set of parameters and repeating said processing using the modified set of parameters.

4. A method as recited in claim 1, wherein analyzing the image data comprises determining a purpose of the scan, a scanned region, and information about a patient who is the subject of the scan.

5. A method as recited in claim 4, wherein analyzing the image data comprises using data specified by a radiation region information system or a hospital information system.

6. A method as recited in claim 1, wherein analyzing the image data comprises using information contained in DICOM header information of DICOM image data.

7. A method as recited in claim 1, wherein analyzing the image data comprises using a human body atlas represented by a three-dimensional graph indicating the construction of a human body.

8. A method as recited in claim 1, wherein analyzing the image data comprises using CT values indicating regions of a human body.

9. A method as recited in claim 1, wherein analyzing the image data comprises:
using information contained in DICOM header information of DICOM image data;
using a human body atlas represented by a three-dimensional graph indicating the construction of a human body; and
using CT values indicating regions of a human body.

10. A method as recited in claim 1, wherein said analyzing further comprises analyzing the image data to determine a scanned region and a target of the scan.

11. A three-dimensional image display system comprising:
a data analysis device to input a set of medical image data created by a scan performed by a medical imaging device, and to determine a set of analytic protocols for processing the image data by analyzing the image data; and
a data processing device to process the image data according to a protocol of said set of analytic protocols, as specified by the data analysis device, and according to a set of parameters identified by the data analysis device.

12. A three-dimensional image display system as recited in claim 11, further comprising:
a parameter storage device to store a set of parameters resulting from processing the medical image data according to a protocol; and
a knowledge database storing information relating to past analyses of medical image data.

13. A three-dimensional image display system as recited in claim 12, wherein the knowledge base is based on DICOM information.

14. A three-dimensional image display system as recited in claim 11, wherein the data analysis device is further to:
automatically determine if a result of processing the image data is satisfactory; and
if the result of processing the image data is not satisfactory, to modify the set of parameters and cause the data processing device to reprocess the image data using the modified set of parameters.

15. A three-dimensional image display system as recited in claim 11, wherein the data analysis device is to analyze the image data by determining a purpose of the scan, a scanned region, and information about a patient who is the subject of the scan.

16. A three-dimensional image display system as recited in claim 15, wherein the data analysis device is to analyze the image data by using data specified by a radiation region information system or a hospital information system.

17. A three-dimensional image display system as recited in claim 11, wherein the data analysis device is to analyze the image data by using information contained in DICOM header information of DICOM image data.

18. A three-dimensional image display system as recited in claim 11, wherein the data analysis device is to analyze the image data by using a human body atlas represented by a three-dimensional graph indicating the construction of a human body.

19. A three-dimensional image display system as recited in claim 11, wherein the data analysis device is to analyze the image data by using CT values indicating regions of a human body.

20. A three-dimensional image display system as recited in claim 11, wherein the data analysis device is to analyze the image data by:
using information contained in DICOM header information of DICOM image data;
using a human body atlas represented by a three-dimensional graph indicating the construction of a human body; and
using CT values indicating regions of a human body.

21. A three-dimensional image display system as recited in claim 11, wherein the data analysis device further is to determine a scanned region and a target of the scan.

22. A three-dimensional image display system comprising:
means for receiving and storing image data aggregates containing scans realized with an image diagnosis device and scan-related information;
a knowledge database to store image data contained in a human body atlas and information pertaining to scans previously performed with an image diagnosis device;
means for defining an analysis protocol determining the procedure for image analysis by performing image analysis on the image data;
means for analyzing information obtained from the image data aggregates containing scan-related information and scans performed with an image analysis device, from a hospital information system (HIS), from a radiology information system (RIS), information obtained from the knowledge database and information about a purpose of the scan and a scan region of the scan;
an analytic engine to execute an image diagnosis sequence required to execute an analysis protocol and a related image analysis;
a software application function for image analysis corresponding to an analysis protocol;
a preprocessing device, equipped with a function to perform an analysis of a target of the scan and of the scan region, applied to an aggregate of image data of scans performed with an image diagnosis device, wherein a corresponding analysis protocol is selected, executing sequentially image analysis sequences based on an analysis protocol with the analysis engine, determining automatically characteristic values and various types of analytic parameters required by the image analysis application software, and performing the output and storage thereof;
means for determining various types of analytic parameters and characteristic values applied to said image data aggregates in order to read and interpret or to perform an image analysis of image data aggregates with the preprocessing device, used to operate image analysis application software according to an analysis protocol so that the analysis image requested by an operator is displayed, and the analytic data and characteristic values can be reproduced; and
an image display device, equipped with a function to enable an operator to correct various types of parameters and characteristic values requested by the preprocessing device in respective steps of image analysis sequences constructed with image analysis application software.

23. A three-dimensional image display system as recited in claim 22, wherein the preprocessing device is equipped with a function to output various types of parameters and characteristic values required to prepare a reading and interpretation report.

24. A three-dimensional image display system as recited in claim 22, wherein the preprocessing device and the image display device are deployed in the same hardware.

25. A three-dimensional image display system as recited in claim 22, wherein the preprocessing device and the image display device are deployed in different hardware.

26. A three-dimensional image display system as recited in claim 22, wherein the preprocessing device and the image display device are distributed over a network.
